(19) United States
(12) Patent Application Publication
(10) Pub. No.: US 2011/0320048 A1
(43) Pub. Date: Dec. 29, 2011

(54) Intergrated monitoring and control apparatus and method for heat tracing system using Zigbee communication

(75) Inventor: Taeyeon Kim, Gyeonggi-do (KR)

(73) Assignee: GEODONG CO., LTD., Gyeonggi-do (KR)

(21) Appl. No.: 13/064,514

(22) Filed: Mar. 30, 2011

(30) Foreign Application Priority Data
Jun. 29, 2010 (KR) 10-2010-0061658

(51) Int. Cl. G05D 7/06

(52) U.S. Cl. 700/282

(57) ABSTRACT

A sensing and control system using ZigBee communication includes a power control radio node (PCRN) for transmitting, through ZigBee communication, sensing data generated by sensors connected to various fluid pipes and containers, or receiving a prescribed control command using ZigBee communication, and a control panel radio node (CPRN) for transmitting the sensing data received through ZigBee communication to a server, or controlling the various fluid pipes and containers by receiving the prescribed control command and by transmitting the prescribed control command to the PCRN.

### BACKGROUND OF THE INVENTION

1. Field of the Invention

The present invention relates to an integrated monitoring and control apparatus and method for a heat tracing system using ZigBee communication.

2. Description of the Related Art

In a batch processing system such as a large chemical plant, processes are automatically performed by sectional control or central control. In such a batch processing system, a determination as to whether each specific device has encountered an error should be rapidly made. However, in a large plant consisting of voluminous and numerous devices, it is not easy recognize errors in real time.

Conventionally, users have to manually check whether each device has an operational error. For an important device, a method has been used for sensing an error through an error sensor and transmitting the presence/absence of an error to a control room by wire.

The method for automatically transmitting presence/absence of an error by wire is the most effective because errors can be recognized in real time and there is no need to check the error manually. However, it is very inefficient to attach sensors to the devices of the large plant and to connect the attached sensors to each other by wire. Moreover, installation costs of the sensors are increased. In addition, provision of space to connect the sensors by wire in the existing plant is problematic.

Meanwhile, in a large plant, temperature control of a variety of fluid pipes and containers ranging from a few hundred kilometers to several thousand kilometers and containers are important and to this end only a room temperature is measured. However, it is difficult to accurately sense the temperatures of the various fluid pipes and containers by measuring only the room temperature.

In a large plant, thermostats are often installed at the various fluid pipes and containers to control temperatures thereof. However, it is nearly impossible to individually check a few thousand to several tens of thousand thermostats installed at the various fluid pipes and containers.

### SUMMARY OF THE INVENTION

Therefore, the present invention has been made in view of the above problems, and it is an object of the present invention to provide a sensing and control system using ZigBee communication.

It is another object of the present invention to provide an integrated monitoring and control apparatus for a heat tracing system using ZigBee communication.

It is a further object of the present invention to provide a sensing and control method using ZigBee communication.

It is another object of the present invention to provide an integrated monitoring and control method for a heat tracing system using ZigBee communication.

In accordance with an aspect of the present invention, the above and other objects can be accomplished by the provision of a sensing and control system using ZigBee communication, including a power control radio node (PCRN) for transmitting, through ZigBee communication, sensing data generated by sensors connected to various fluid pipes and containers, or receiving a prescribed control command using ZigBee communication, and a control panel radio node (CPRN) for transmitting the sensing data received through ZigBee communication to a server, or controlling the various fluid pipes and containers by receiving the prescribed control command from the server and by transmitting the prescribed control command to the PCRN.

In accordance with another aspect of the present invention, there is provided an integrated monitoring and control apparatus for a heat tracing system using ZigBee communication, including a power control radio node (PCRN) for transmitting, through ZigBee communication, temperature data of various fluid pipes and containers generated by sensors connected to the various fluid pipes and containers, or receiving a temperature control command for the various fluid pipes and containers using ZigBee communication to control temperatures of the various fluid pipes and containers, and a control panel radio node (CPRN) for receiving the temperature data from the PCRN through ZigBee communication to provide the temperature data to a server, or receiving the temperature control command from the server to transmit the temperature control command to the PCRN.

In accordance with a further aspect of the present invention, there is provided a sensing and control method using ZigBee communication, including transmitting, by a power control radio node (PCRN), sensing data generated by sensors connected to various fluid pipes and containers to a local control panel radio node (LPRN) through ZigBee communication, receiving and analyzing, by the LPRN, the sensing data, transmitting, by the LPRN, the received sensing data to a main control panel radio node (MCPRN) through ZigBee communication, and receiving, by the MCPRN, the sensing data through ZigBee communication, transmitting the received sensing data to a server, and receiving a control command from the server to transmit the control command to the various fluid pipes and containers.

In accordance with another aspect of the present invention, there is provided an integrated monitoring and control method for a heat tracing system using ZigBee communication, including transmitting, by a power control radio node (PCRN), temperature data of various fluid pipes and containers generated by sensors connected to the various fluid pipes and containers through ZigBee communication, receiving and analyzing, by a local control panel radio node (LPRN), the temperature data, transmitting, by the LPRN, the received temperature data to a main control panel radio node (MCPRN) through ZigBee communication, and, receiving, by the MCPRN, the temperature data through ZigBee communication, transmitting the received temperature data to a server, and transmitting a temperature control command of the various fluid pipes and containers received from the server to the PCRN.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram of a sensing and control system using ZigBee communication according to an exemplary embodiment of the present invention;

FIG. 2 is a conceptual diagram of a sensing and control system using ZigBee communication according to an exemplary embodiment of the present invention;

FIG. 3 is a block diagram of a power control radio node according to an exemplary embodiment of the present invention;

FIG. 4 is a block diagram of a local control panel radio node according to an exemplary embodiment of the present invention;

FIG. 5 is a block diagram of a main control panel radio node according to an exemplary embodiment of the present invention;

FIG. 6 is a block diagram of a relay node according to an exemplary embodiment of the present invention;

FIG. 7 is a flowchart of a sensing and control method using ZigBee communication according to an exemplary embodiment of the present invention; and

FIG. 8 is a flowchart of an integrated monitoring and control method for a heat tracing system using ZigBee communication according to an exemplary embodiment of the present invention.

### DETAILED DESCRIPTION OF THE INVENTION

Reference will now be made in detail to the exemplary embodiments of the present invention with reference to the accompanying drawings.

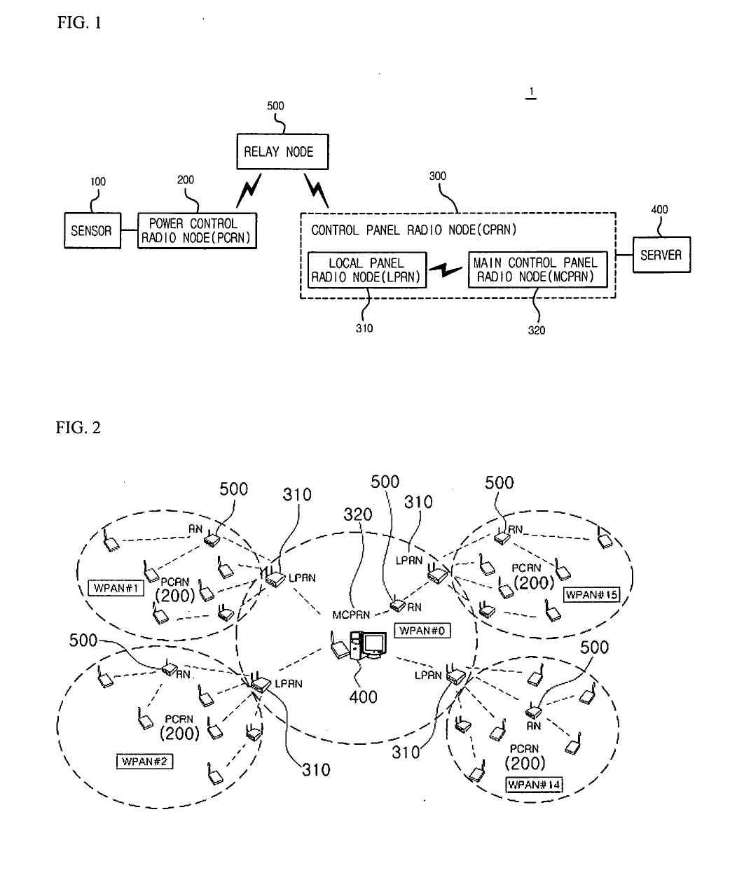

Referring to FIG. 1, a sensing and control system 1 using ZigBee communication, (hereinafter, referred to as a ‘sensing and control system’), includes a sensor 100, a power control radio node 200, a control panel radio node 300, a server 400, and a relay node 500. The control panel radio node 300 includes a local control panel radio node 310 and a main control panel radio node 320.

The sensing and control system 1 senses operational errors of specific devices in a system such as a large plant and takes measures to cope with the errors. Numerous sensors are attached to the respective devices. The sensing and control system 1 receives sensing data generated by the sensors using ZigBee communication and controls the specific devices. An application example of the sensing and control system 1 is a heat tracing system. An integrated monitoring and control apparatus applied to the heat tracing system senses and controls the temperatures of various fluid pipes and containers of the large plant.

A detailed concept of the sensing and control system 1 is described with reference to FIG. 2.

The sensing and control system 1 forms several wireless personal area networks (WPANs), and includes a plurality of sensors (not shown), power control radio nodes (PCRNs) 200 respectively connected to the sensors, local control panel radio nodes (LPRNs) 310 for managing the personal area networks, a main control panel radio node (MCPRN) 320 for managing the LPRNs 310, a server 400 connected to the MCPRN 320, and relay nodes (RNs) 500 for relaying the LPRNs 310 to the PCRNs 200. Data is exchanged between the PCRNs 200, RNs 500, and LPRNs 310 using ZigBee communication. The WPAN is a small size wireless network having a diameter of about 30 to 100 meters.

A plurality of WPANs may be formed in a large petrochemical plant or a power station. The sensing and control system 1 collects sensing data transmitted from sensors (not shown) in each WPAN through the MCPRN 320 using ZigBee communication and provides the sensing data to the server 400. The server 400 analyzes the sensing data and issues a proper control command. The RN 500 performs a relay function using ZigBee communication when a distance between the PCRN 200 and the LPRN 310 is far away.

A detailed configuration of the sensing and control system is described with reference to FIG. 1.

The sensor 100 senses the operation states of various devices installed in a large chemical plant or a power station and generates sensing data. The sensing data generated by the sensor 100 may be voltage, current, wire break detection/non-detection, temperature, etc. In the heat tracing system, temperature sensors may be installed at various fluid pipes and containers and the temperature sensors may sense the temperatures of the fluid pipes and containers to generate temperature data. That is, the present invention may be configured to integrally monitor and control the temperatures of various fluid pipes and containers in the heat tracing system.

The PCRN 200 transmits the sensing data generated by the sensor 100 using ZigBee communication or receives a prescribed control command using ZigBee communication. The PCRN 200 may be configured to include the sensor 100. Since the sensing data is transmitted using ZigBee communication through PCRN 200, the sensing and control system 1 is very advantageous in terms of installation costs and efficiency when compared to wired communication. In the case of the heat tracing system, the PCRN 200 transmits temperature data of various fluid pipes and containers, generated by the sensor 100 attached to the various fluid pipes and containers, using ZigBee communication or receives a temperature control command for the various fluid pipes and containers using ZigBee communication, thereby controlling the temperatures of the various fluid pipes and containers.

Meanwhile, the sensor 100 for sensing temperature may be attached to the various fluid pipes and containers, as described above. In a large plant for example, since the length of each of the fluid pipes and containers ranges from a few hundred kilometers to several thousand kilometers, temperatures thereof are different. The sensor 100 may be attached to every prescribed unit length of the fluid pipes and containers. One sensor 100 is desirably installed every 100 meters.

The PCRN 200 may be configured to control the temperatures of the fluid pipes and containers by adjusting the temperatures of heating cables and tapes attached to the fluid pipes and containers. In this case, the PCRN 200 may be configured to control the temperatures of the heating cables and tapes attached to every circuit of a prescribed unit length constituting the fluid pipes and containers.

ZigBee communication is very advantageous in that it is possible to form an ad-hoc network. In ZigBee communication, there are 16 available channels and therefore a large number of WPANs may be formed.

Meanwhile, the PCRN 200 may be configured to transmit the sensing data at prescribed intervals. Since the sensing data should be periodically monitored, a period may be set. In the heat tracing system, the PCRN 200 may be configured to transmit the temperature data at prescribed intervals.

The CPRN 300 receives the sensing data using ZigBee communication and provides the sensing data to the server 400. The CPRN 300 receives the prescribed control command from the server 400 and controls an associated device. In the heat tracing system, the CPRN 300 may receive temperature data sensed by the sensor 100 using ZigBee communication and provide the temperature data to the server 400. In addition, the CPRN 300 may receive a temperature control command from the server 400 and transmit the temperature control command to the PCRN 200.

The CPRN 300 may have an input means for displaying the sensing data so that a user may directly analyze the sensing data or causing a user to generate the control command.

Meanwhile, the CPRN 300 may be configured to receive upper and lower values for the sensing data from the server 400, sets the upper and lower values, and compare the sensing data received from the PCRN 200 with the upper and lower values to generate a real-time alert. [symbol] , [symbol] [symbol] [symbol] (300) [symbol] [symbol] [symbol] [symbol] In the heat tracing system, the CPRN 300 may be configured to receive upper and lower values for the temperature data from the server 400, set the upper and lower values, and compare the temperature data received from the PCRN 200 with the upper and lower values to generate a real-time alert. In the heat tracing system, the PCRN 200 may be configured to control the temperatures of the various fluid pipes and containers by controlling the temperatures of heating cables and tapes attached to the various fluid pipes and containers.

In this case, if a value of the sensing data deviates from a range defined by the upper value or the lower value, the CPRN 300 may generate a real-time alert and may generate a control command for automatically turning on or off a power source of a power cable of an associated device according to a range of the value of the sensing data. The CPRN 300 may be separately comprised of the LPRN 310 and the MCPRN 320 according to the scale of a petrochemical plant, an electric power station, or the like. The LPRN 310 and the MCPRN 320 are connected using ZigBee communication. Hereinafter, a detailed configuration of the CPRN 300 is described.

The LPRN 310 may be configured to receive the sensing data from a plurality of PCRNs 200 constituting a WPAN and transmit the control command to an associated device. The associated device is a power kit of a device to which the sensor 100 is attached and may be a device for supplying or cutting off a power source. In the case of the heat tracing system, the LPRN 310 may be configured to receive temperature data from a plurality of PCRNs constituting a WPAN and transmit a temperature control command to the PCRN 200.

The MCPRN 320 may be configured to receive the sensing data from the LPRN 310, receive the control command from the server 400, and transmit the control command to the LPRN 310. In this case, the MCPRN 320 is configured to collect the sensing data from each LPRN 310. The MCPRN 320 may be directly connected to the server 400. In the heat tracing system, the MCPRN 320 may be configured to receive temperature data from the LPRN 310, and receive a temperature control command from the server 400 to transmit the temperature control command to the LPRN 310.

The server 400 receives the sensing data from the MCPRN 320, stores and analyzes the sensing data, and generates a control command. A personal computer may be used as the server 400.

The relay node 500 relays ZigBee communication between the PCRN 200 and the CPRN 300. If the relay node 500 is further installed, ZigBee communication is possible over distances of 1 kilometer or more. If the CPRN 300 is comprised of the LPRN 310 and the MCPRN 320, the relay node 500 performs a relay function between the LPRN 310 and PCRN 200. In the case of the heat tracing system, it is apparent that the relay node 500 may be further provided for relaying ZigBee communication between the PCRN 200 and the CPRN 300.

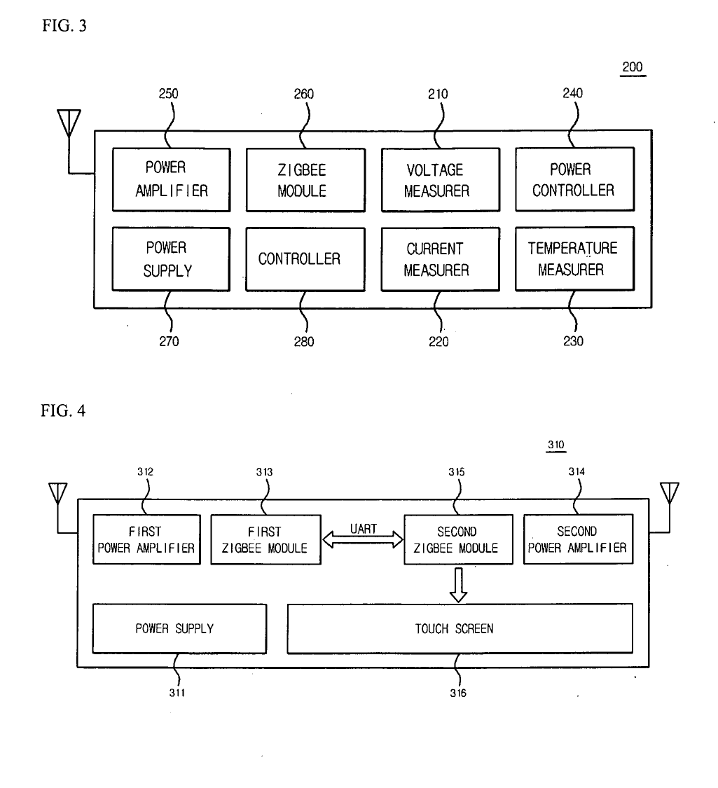

FIG. 3 is a block diagram of a PCRN 200 according to an exemplary embodiment of the present invention. Referring to FIG. 3, the PCRN 200 includes a voltage measurer 210, a current measurer 220, a temperature measurer 230, a power controller 240, a power amplifier 250, a ZigBee module 260, a power supply 270, and a controller 280. Hereinafter, a detailed configuration of the PCRN 200 is described.

The voltage measurer 210 receives sensing data about a voltage from the sensor 100, measures a voltage, and provides the measured voltage to the ZigBee module 260. Similarly, the current measurer 220 and the temperature measurer 230 receive sensing data about current and temperature from the sensor 100, measure current and temperature, and provide the measured current and temperature to the ZigBee module 260. The power amplifier 250 amplifies transmitted and received powers of the ZigBee module 260. The power amplifier 250 ensures a communication range of at least 100 meters. The ZigBee module 260 performs ZigBee communication with the CPRN 300. The controller 280 controls the overall operation of the PCRN 200.

FIG. 4 is a block diagram of the LPRN 310 according to an exemplary embodiment of the present invention. Referring to FIG. 4, the LPRN 310 includes a power supply 311, a first power amplifier 312, a first ZigBee module 313, a second power amplifier 314, a second ZigBee module 315, and a touchscreen 316. Hereinafter, a detailed configuration of the LPRN 310 is described.

The power supply 311 supplies a power source. The first power amplifier 312 amplifies transmitted and received powers of the first ZigBee module 313. The first power amplifier 312 ensures a communication range of at least 100 meters. The first ZigBee module 313 receives sensing data from the PCRN 200 and transmits the sensing data to the second ZigBee module 315 using protocol such as a universal asynchronous receiver/transmitter (UART). The second power amplifier 314 amplifies transmitted and received powers of the second ZigBee module 315. The second power amplifier 314 ensures a communication range of at least 100 meters. The second ZigBee module 315 transmits the sensing data received from the first ZigBee module 313 or a real-time alert message to the MCPRN 320, or receives a control command from the MCPRN 320. The touchscreen 316 is used as a means for analyzing measurement values of the sensing data and displaying the real-time alert message. The touch screen 316 is also used as a means for inputting upper and lower values of the measurement values or various control commands.

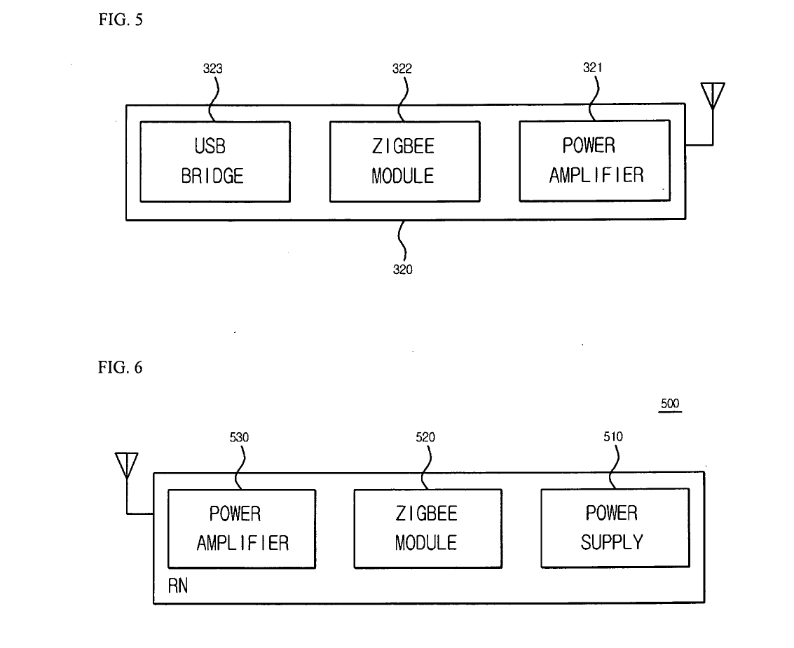

FIG. 5 is a block diagram of the MCPRN 320 according to an exemplary embodiment of the present invention. Referring to FIG. 5, the MCPRN 320 includes a power amplifier 321, a ZigBee module 322, and a universal serial bus (USB) bridge 323. The MCPRN 320 may be connected to the server 400 through a USB. Hereinafter, a detailed configuration of the MCPRN 320 is described.

The power amplifier 321 amplifies transmitted and received powers of the ZigBee module 322. The power amplifier 321 ensures a communication range of at least 100 meters. The ZigBee module 322 performs ZigBee communication with the LPRN 310. The ZigBee module 322 transmits received sensing data or a real-time alert message to the USB bridge 323 or transmits a control command to the LPRN 310. The USB bridge 323 transmits the sensing data received from the ZigBee module 322 to the server 400, or receives a control command from the server 400 to transmit the control command to the ZigBee module 322.

FIG. 6 is a block diagram of the relay node 500 according to an exemplary embodiment of the present invention. Referring to FIG. 6, the relay node 500 includes a power supply 510, a ZigBee module 520, and a power amplifier 530. Hereinafter, a detailed configuration of the relay node 500 is described.

The power supply 510 supplies a power source. The ZigBee module 520 performs a relay function between the PCRN 200 and the CPRN 300. The power amplifier 530 amplifies transmitted and received powers of the ZigBee module 520.

One relay node 500 may be provided per PCRN 200. It is desirable to ensure about 1 kilometer or more of a radio distance through the relay node 500. The relay node 500 measures a received signal strength indication (RSSI) from the PCRN 200 and may be installed at a location where the RSSI is about −80 dBm.

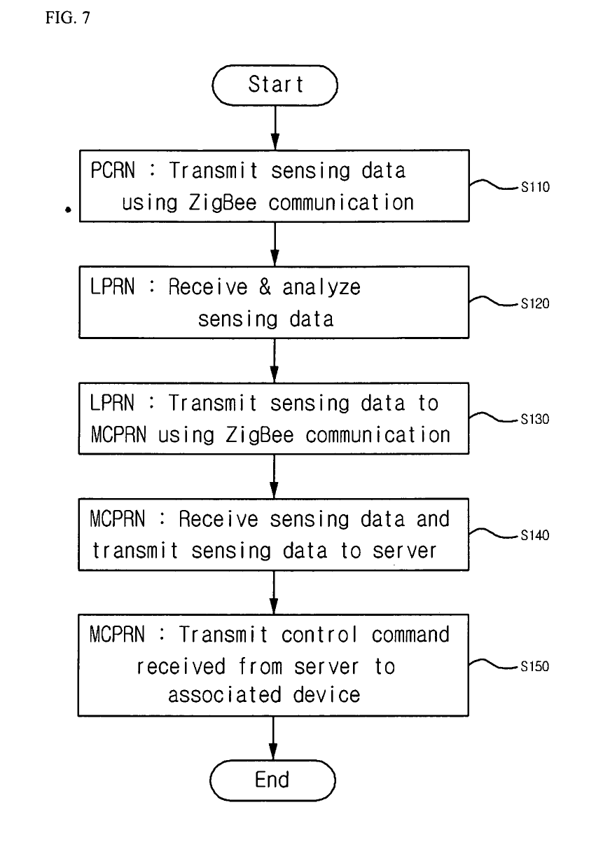

FIG. 7 is a flowchart of a sensing and control method using ZigBee communication according to an exemplary embodiment of the present invention. Referring to FIG. 7, the PCRN 200 transmits sensing data generated by the sensor 100 using ZigBee communication (step S110). The sensing data generated by the sensor 100 may be voltage, current, wire break detection/non-detection, temperature, etc. The PCRN 200 may transmit the sensing data at prescribed intervals.

The LPRN 310 receives and analyzes the sensing data (step S120). If the sensing data deviates from a preset range as a result of the analysis, the LPRN 310 may transmit a real-time alert to the MCPRN 320.

The LPRN 310 transmits the received sensing data to the MCPRN 320 using ZigBee communication (step S130).

The MCPRN 320 receives the sensing data and transmits the received sensing data to the server 400 (step S140).

The MCPRN 320 transmits a control command received from the server 400 to an associated device using ZigBee communication (step S150). The MCPRN 320 may receive a control command for turning on or off a power source of a power cable.

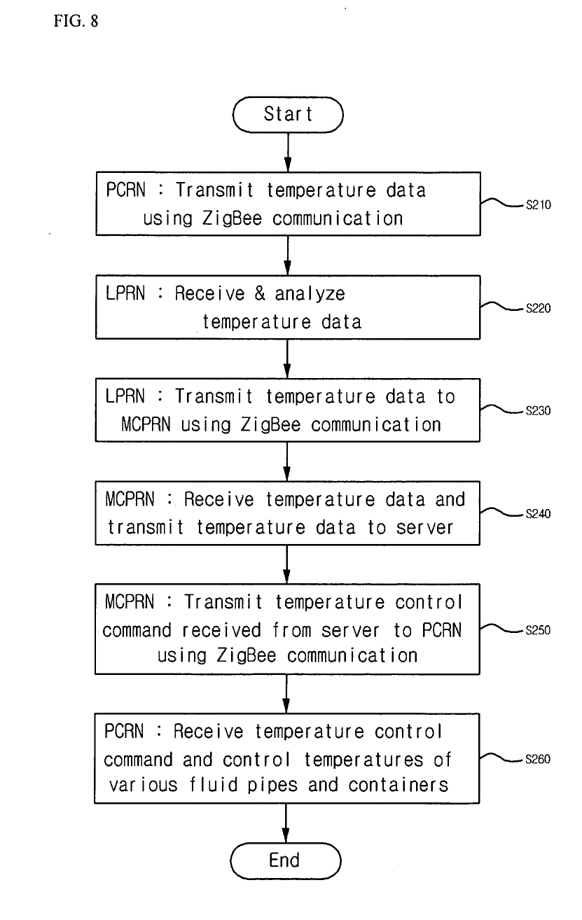

FIG. 8 is a flowchart of an integrated monitoring and control method for a heat tracing system using ZigBee communication according to an exemplary embodiment of the present invention. Referring to FIG. 8, the PCRN 200 transmits temperature data of various fluid pipes and containers generated by the sensor 100 using ZigBee communication (step S210).

The LPRN 310 receives and analyzes the temperature data (step S220). If the temperature data deviates from a preset range as a result of the analysis, the LPRN 310 may transmit a real-time alert to the MCPRN 320.

The LPRN 310 transmits the received temperature data to the MCPRN 320 using ZigBee communication (step S230).

The MCPRN 320 receives the temperature data and transmits the received temperature data to the server 400 (step S240).

The MCPRN 320 transmits a temperature control command of the various fluid pipes and containers received from the server 400 to the PCRN 200 using ZigBee communication (step S250).

The PCRN 200 receives the temperature control command, and controls temperatures of the various fluid pipes and containers by controlling temperatures of heating cables and tapes attached to the various fluid pipes and containers according to the received temperature control command (step S260). In this case, temperatures of heating cables and tapes attached to every circuit of a prescribed unit length constituting the various fluid pipes and containers may be controlled.

As is apparent from the above description, the present invention provides an integrated monitoring and control apparatus and method for a heat tracing system using ZigBee communication, in which a sensor is attached to each device of a large plant to receive sensing data using ZigBee communication. Accordingly, operational errors are sensed in real time and the apparatus and method may take measures to address the error. Moreover, difficulty in installing sensors using a wired method may be eliminated and large amount of sensing data may be obtained.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A sensing and control system using ZigBee communication, comprising:
a power control radio node (PCRN) for transmitting, through ZigBee communication, sensing data generated by sensors connected to various fluid pipes and containers, or receiving a prescribed control command using ZigBee communication; and
a control panel radio node (CPRN) for transmitting the sensing data received through ZigBee communication to a server, or controlling the various fluid pipes and containers by receiving the prescribed control command from the server and by transmitting the prescribed control command to the PCRN.

2. The sensing and control system according to claim 1, further Comprising a relay node for relaying ZigBee communication between the PCRN and the CPRN.

3. The sensing and control system according to claim 2, wherein the PCRN transmits the sensing data at prescribed intervals.

4. The sensing and control system according to claim 3, wherein the CPRN receives upper and lower values of the sensing data from the server, sets the upper and lower values, compares the sensing data received from the PCRN with the set upper and lower values, and generates a real-time alert when a value of the sensing data deviates from a range defined by the upper value or the lower value.

5. The sensing and control system according to claim 4, wherein the control command is a control command for turning on or off power sources of power cables connected to the various fluid pipes and containers.

6. The sensing and control system according to claim 5, wherein the sensing data generated by the sensors includes voltage, current, wire break detection/non-detection, or temperature.

7. The sensing and control system according to claim 6, wherein the CPRN includes:
a local control panel radio node (LPRN) for receiving sensing data from a plurality of PCRNs constituting a personal area network, and transmitting the control command to the PCRNs; and
a main control panel radio node (MCPRN) for receiving the sensing data from the LPRN, and receiving the control command from the server to transmit the control command to the LPRN.

8. An integrated monitoring and control apparatus for a heat tracing system using ZigBee communication, comprising:
a power control radio node (PCRN) for transmitting, through ZigBee communication, temperature data of various fluid pipes and containers generated by sensors connected to the various fluid pipes and containers, or receiving a temperature control command for the various fluid pipes and containers using ZigBee communication to control temperatures of the various fluid pipes and containers; and
a control panel radio node (CPRN) for receiving the temperature data from the PCRN through ZigBee communication to provide the temperature data to a server, or receiving the temperature control command from the server to transmit the temperature control command to the PCRN.

9. The integrated monitoring and control apparatus according to claim 8, wherein the PCRN controls the temperatures of the various fluid pipes and containers by controlling temperatures of heating cables and tapes attached to the various fluid pipes and containers.

10. The integrated monitoring and control apparatus according to claim 9, wherein the PCRN controls the temperatures of heating cables and tapes attached to every prescribed unit length of the various fluid pipes and containers.

11. The integrated monitoring and control apparatus according to claim 10, wherein the PCRN transmits the temperature data at prescribed intervals.

12. The integrated monitoring and control apparatus according to claim 11, wherein the CPRN receives upper and lower values of the temperature data from the server, sets the upper and lower values, compares the temperature data received from the PCRN with the set upper and lower values, and generates a real-time alert when a value of the temperature data deviates from a range defined by the upper value or the lower value.

13. The integrated monitoring and control apparatus according to claim 12, further comprising a relay node for relaying ZigBee communication between the PCRN and the CPRN.

14. The integrated monitoring and control apparatus according to claim 13, wherein the CPRN includes:
a local control panel radio node (LPRN) for receiving sensing data from a plurality of PCRNs constituting a personal area network, and transmitting the temperature control command to the PCRNs; and
a main control panel radio node (MCPRN) for receiving the temperature data from the LPRN, and receiving the temperature control command from the server to transmit the temperature control command to the LPRN.

15. A sensing and control method using ZigBee communication, comprising:
transmitting, by a power control radio node (PCRN), sensing data generated by sensors connected to various fluid pipes and containers to a local control panel radio node (LPRN) through ZigBee communication;
receiving and analyzing, by the LPRN, the sensing data;
transmitting, by the LPRN, the received sensing data to a main control panel radio node (MCPRN) through ZigBee communication; and
receiving, by the MCPRN, the sensing data through ZigBee communication, transmitting the received sensing data to a server, and receiving a control command from the server to transmit the control command to the various fluid pipes and containers.

16. The sensing and control method according to claim 15, wherein the receiving and analyzing of the sensing data includes transmitting, by the LPRN, a real-time alert to the MCPRN, when the sensing data deviates from a range defined by an upper value or a lower value for the sensing data received from the server as a result of the analysis.

17. The sensing and control method according to claim 16, wherein the transmitting by the PCRN of the sensing data includes transmitting the sensing data at prescribed intervals.

18. The sensing and control method according to claim 17, wherein the transmitting by the MCPRN of the control command includes transmitting a control command for turning on or off power sources of power cables connected to the various fluid pipes and containers.

19. The sensing and control method according to claim 18, wherein the sensing data generated by the sensors is voltage, current, wire break detection/non-detection, or temperature.

20. An integrated monitoring and control method for a heat tracing system using ZigBee communication, comprising:
transmitting, by a power control radio node (PCRN), temperature data of various fluid pipes and containers generated by sensors connected to the various fluid pipes and containers through ZigBee communication;
receiving and analyzing, by a local control panel radio node (LPRN), the temperature data;
transmitting, by the LPRN, the received temperature data to a main control panel radio node (MCPRN) through ZigBee communication; and
receiving, by the MCPRN, the temperature data through ZigBee communication, transmitting the received temperature data to a server, and transmitting a temperature control command of the various fluid pipes and containers received from the server to the PCRN.

21. The integrated monitoring and control method according to claim 20, wherein the receiving and analyzing of the temperature data includes transmitting, by the LPRN, a real-time alert to the MCPRN, when the temperature data deviates from a range defined by an upper value or a lower value for the temperature data received from the server as a result of the analysis.

22. The integrated monitoring and control method according to claim 21, further comprising receiving, by the PCRN, the temperature control command, and controlling temperatures of the various fluid pipes and containers by controlling temperatures of heating cables and tapes attached to the various fluid pipes and containers according to the received temperature control command.

23. The integrated monitoring and control method according to claim 22, wherein the receiving by the PCRN of the temperature control command and controlling of the temperatures of the various fluid pipes and containers includes controlling temperatures of heating cables and tapes attached to every prescribed unit length of the various fluid pipes and containers.
